(19) United States
(12) Patent Application Publication
(10) Pub. No.: US 2006/0284708 A1
(43) Pub. Date: Dec. 21, 2006

(54) Dielectrically loaded coaxial resonator

(75) Inventor: Timothy Blayne Reeves, Amesbury, MA (US)

Correspondence Address: LOTT & FRIEDLAND, P.A., P.O. BOX 141098, CORAL GABLES, FL, 33114-1098, US

(73) Assignee: MASIONS OF THOUGHT, R&D, L.L.C.

(21) Appl. No.: 11/355,019

(22) Filed: Feb. 15, 2006

Related U.S. Application Data
(60) Provisional application No. 60/690,772, filed on Jun. 15, 2005.

(51) Int. Cl. H01P 7/04

(52) U.S. Cl. 333/222

(57) ABSTRACT

A coaxial resonator comprising a conductive housing, a conductive cylindrical post and a high dielectric constant tubular ceramic insert. The above elements are arranged such that the post and ceramic insert are stacked and attached to the housing so that the bottom surface of the post abuts the floor of the housing while the top surface of the ceramic insert abuts the roof of the housing.

### CLAIM OF PRIORITY

This application claims the benefit of and incorporates by reference co-pending U.S. patent application Ser. No. 60/690,772, filed on Jun. 15, 2005.

### TECHNICAL FIELD

The present invention relates generally to the field of filtering electromagnetic energy in the radio or microwave frequency regions. Specifically, the disclosed invention relates to a dielectrically loaded coaxial resonator for use in electromagnetic wireless base-station filters, microwave oscillators or other applications in which microwave and high frequency signal conditioning is performed.

### BACKGROUND OF THE INVENTION

Coaxial resonators are devices used in a variety of applications requiring microwave and high frequency signal filtering and conditioning. The most common application of coaxial resonators is as components in filtering equipment at cellular telephone base stations and microwave frequency transmission the

Coaxial resonators are structures that at microwave frequencies have a set of inherent electrical resonant frequencies dependent upon the resonator's geometry and the inherent characteristics of the materials used to construct the resonator. A resonator with a given mix of dimensions, shapes and materials will have an infinite number of natural frequencies at which it will resonate. Generally speaking, only the lowest of the natural frequencies is the “primary”, or target, frequency which is sought to be filtered by the resonator. The next lowest resonating frequency is referred to as the “first spurious mode” frequency.

Physically, a coaxial resonator consists of a hollow enclosure having a floor, a roof and walls. A coaxial resonator further includes a longitudinal structure, or “post” mechanically affixed at or near the center of its floor and extending perpendicularly in the direction of the roof. The post generally extends for most of the cavity height except for a short air gap between its top end and the roof of the cavity enclosure. The electromagnetic characteristics of the resonator are dependant on the shapes and dimensions of the cavity, post and air gap as well as the materials utilized for the construction of the various components.

In addition to the above, existing resonator designs incorporate additional elements, or inserts, that can be placed between the top of the post and the roof of the cavity to reduce, but not eliminate, the size of the air gap to alter the characteristics of the resonator. Also, additional moveable elements, such as tuning screws, can be incorporated into the design to allow for minor tuning of the primary frequency for the resonator.

The post, cavity and insert dimensions and shapes are chosen so that the structure's primary resonant frequency corresponds to a specific value. The first important characteristic of a resonator design is its resonant sharpness. Resonant sharpness, usually designated at the resonator's “Quality Factor” or “unloaded Q-factor” is a measure of the degree to which the resonator responds to its target resonant frequency in. comparison to adjacent frequencies. A resonator having a high Quality Factor will demonstrate a sudden increase in response as the input frequency approaches the target frequency as well as a sudden drop in response as the input frequency diverges from the target frequency. The Quality Factor is generally measured as the ratio between the primary frequency and the response bandwidth for the resonator at the primary frequency. It is a desirable characteristic of a resonator to have the highest possible Quality Factor.

A second, important characteristic of a resonator is the frequency separation between the primary resonant frequency and the spurious mode frequency. Increased separation is desirable in order to avoid the response to an undesired frequency by the resonator. Increased separation is also desirable because the most common method for eliminating spurious mode frequencies is by pre-processing or post processing the input signal using a low-pass filter. The greater the separation between the spurious mode and primary frequencies, the greater the range of frequencies will be that the low-pass filter can allow to flow through. Moreover, if separation is great enough, no low-pass filter is required thus reducing the complexity, cost, volume and weight of the equipment.

The third important characteristic of a resonator is the overall volume occupied by its physical structure. It is always desirable for purposes of functionality, cost and weight to have the smallest volume possible.

Thus an ideal resonator would have a very high Q-value, a high spurious mode frequency separation, and a very low physical volume. A particular design usually involves a tradeoff between these characteristics in order to achieve the desired resonator type. The coaxial resonator disclosed in the present application comprises a novel combination of geometry, elements and materials which provides advantages over existing devices by enabling a resonator with much reduced volume, increased spurious mode separation and a relatively high Quality Factor.

Previous resonator designs are described in United States Patent Application Publication No. 2004/0257176 of Pance et al.; U.S. Pat. No. 6,784,768 to Pance et al.; U.S. Pat. No. 6,707,353 to Yamakawa et al.; U.S. Pat. No. 6,538,454 to Frenkel et al.; U.S. Pat. No. 6,362,708 to Woods; U.S. Pat. No. 6,262,639 to Shu et al.; U.S. Pat. No. 5,179,074 to Fiedziuszko; U.S. Pat. No. 4,224,587 to Makimoto et al.; and U.S. Pat. No. 3,818,389 to Fisher.

United States Patent Application Publication No. 2004/0257176 to Pance et al. describes a method and apparatus for dissipating heat in a dielectric resonator circuit in which resonators are mounted to an enclosure by highly thermally and electrically conductive supports, such as metal rods, that pass through the longitudinal through hole in the center of the resonator. The supports preferably are attached within the through holes by a highly thermally conductive, but dielectric sleeve positioned between the support and the resonator. The rod or support has a diameter selected to minimize any reduction in quality factor, Q, for the circuit. Alternately, the support can be a highly thermally conductive dielectric and the inner wall of the through hole can be metalized.

U.S. Pat. No. 6,784,768 to Pance et al. describes a method and apparatus for coupling energy into or out of a dielectric resonator circuit by means of a coupling loop. More particularly, the invention is a method and apparatus for adjustably mounting a coupling loop relative to a resonator, the method and apparatus particularly adapted for use with conical and similar resonators in which the field of interest, typically the TE mode, varies as a function of longitudinal position relative to the resonator. In accordance with this invention, the coupling loop is supported from the distal end of a threaded screw that passes through a matingly threaded hole in the housing The resonator to which the loop is to couple is mounted on the distal end of a second threaded screw that passes through a matingly threaded central passage in the first screw. The position of the resonator, therefore, is longitudinally adjustable relative to the coupling loop by rotation of the second screw relative to the first screw. The resonator is longitudinally adjustable relative to the housing and the other resonators in the circuit by rotation of either the first screw or the second screw. By relative adjustment of the first and second screws to each other, the longitudinal position of the coupling loop relative to the resonator can be adjusted, thereby adjusting the coupling strength between the two. With this mounting technique, the coupling loop can be positioned very closely to the resonator to maximize field coupling. Furthermore, the coupling strength is adjustable by longitudinal adjustment of the coupling loop relative to the conical resonator.

U.S. Pat. No. 6,707,353 to Yamakawa et al. describes a dielectric filter having a metal case, a lid, and a plurality of dielectric resonators arranged through support tables in spaces partitioned by a metal partition wall inside the metal case and characterized in that the dielectric filter is constituted by a combination of at least two types of dielectric resonators having different frequency characteristics in unnecessary harmonic modes except for a main mode near a passing band of the filter. With this configuration, the inventor claims that a spurious pulse can be extremely effectively suppressed.

U.S. Pat. No. 6,538 454 to Frenkel et al. describes a microwave microscope having a resonant slit formed in a highly conductive end of a microwave waveguide forming a probe tip. A short dielectric rod is fit into the waveguide near its conductive end. A longer dielectric rod is placed in back of the short dielectric rod with a small gap between the two rods. The length of the shorter rod and the size of the gap are chosen to form a dielectric resonator at the microwave frequency adjacent to the probe tip. Thereby, the impedance of the waveguide can be matched to the generally high impedance of the slit probe tip. Preferably, the dielectric constant of the materials is high, thereby reducing the size of the waveguide and probe tip relative to the microwave wavelength.

U.S. Pat. No. 6,362,708 to Woods describes a temperature-compensating tuning device for tuning and temperature stabilizing the resonant frequency of a dielectric resonator. The tuning device comprises a tuning element in the form of a cylindrical shaft, an inner sleeve coaxially around the tuning element and mating therewith by corresponding sets of threads, and an outer sleeve coaxially around the inner sleeve, and mating therewith by corresponding sets of threads. The outer surface of the outer sleeve may also include threads for mating with threads of a dielectric resonator enclosure. Rotation of the tuning element, inner sleeve and/or outer sleeve can move the tuning element in proximity to a dielectric resonator, which provides the resonant frequency tuning effect. The tuning element, inner and outer sleeves are made of temperature expanding material to cause the tuning element to move in proximity of the dielectric resonator with temperature changes to provide temperature stability to the resonant frequency.

U.S. Pat. No. 6,262,639 to Shu et al. describes a bandpass filter comprising a housing having a plurality of cavities, wherein said plurality of cavities are isolated from each other by partitions and wherein each said partition have a coupling window; input/output connectors formed at both ends of said housing so as to pass output signals from a transmitter; coupling loops connected to said input/output connectors so as to excite an applied signal power and to combine resonance modes; dielectric resonators installed in said cavities of said housing so as to resonate a signal power transmitted from said coupling loop to the desired frequency band, said dielectric resonators including: a first resonator group formed in both said cavities which are adjacent to said coupling loops; and a second resonator group formed in said cavities which are positioned between both said cavities which are adjacent to said coupling loops, wherein said resonators of said second resonator group are stepped resonators; a plurality of frequency controllers corresponding to said dielectric resonators, being disposed on a top of said dielectric resonators and being apart from said dielectric resonators by a predetermined distance, whereby the second resonator group removes a needless wave characteristic generated by resonance of the higher-order mode, by moving a higher-order mode characteristic from the first resonator group to a higher frequency band than a fundamental mode frequency.

U.S. Pat. No. 5,179,074 to Fiedziuszko describes a waveguide cavity filter having a conductive housing, a plurality of high dielectric constant ceramic resonators disposed within the conductive housing and at least a portion of a sheet of superconductive material which is constrained to be at an ambient temperature below the critical temperature of the superconductor and disposed in contact with at least one of the side walls of the conductive housing and with an opposing surface of each of the resonators, such that the resonators are in close superconductive contact with the side walls of the conductive housing. In particularly, the superconductive sheet is a layer of high temperature superconductor. In a first embodiment of the invention, the resonators in the shape of cylindrical plugs are disposed with a flat surface juxtaposed to the side wall. In a second embodiment, the resonators are in the form of half cylindrical plugs with the axis of the half cylinder transverse to the axis of the resonator, in contact with the superconductor sheet and in juxtaposition to the side wall. In a further embodiment of the invention, the resonators are quarter circular cylindrical plugs and each of the flat side surfaces is in contact with a juxtaposed side wall of the conductive housing through a sheet of superconductive material.

U.S. Pat. No. 4,224,587 to Makimoto et al. describes a comb-line bandpass filter comprising an enclosure or outer conductor and a plurality of inner conductors arranged parallel in the outer conductor. Adjacent to one end of each inner conductor a body of dielectric material is attached to provide a larger diameter, lumped capacitance section while providing a lumped inductance section in the remainder of the inner conductor. A conductive layer, conductively coupled to the outer conductor, encircles the dielectric body to act as a shield between adjacent inner conductors so that the coupling between them is concentrated in the inductive section. Overall size of the comb-line filter is reduced by reduction both in axial length of the inner conductors and the spacing between them.

U.S. Pat. No. 3,818,389 to Fisher describes two interdigital filters combined in a single filter structure. The structure consists of a series of adjacent interdigited elements; each filter including one or more appropriately tuned high Q elements and an input coupling element at one end of the high Q elements. Both filters share a common, intermediately located, output coupling element which is connected to a load. Where the dual filter is used in a mixer circuit the individual input signals may be applied to the input coupling elements at the extreme ends of the interdigital structure and a mixing diode may be mounted at the end of the common output coupling element.

None of the devices disclosed in the prior art describe a design incorporating the novel combination of geometry, elements and materials of the present invention which enable a resonator with much reduced volume, much increased spurious mode separation and a relatively high Quality Factor.

Therefore, there is a need in the prior art to provide a resonator which occupies a much smaller volume than present designs.

There is a further need in the art to provide a resonator that delivers greatly increased spurious mode separation.

There is a further need in the art to provide a resonator with the above characteristics that and has a relatively high Quality Factor.

### SUMMARY OF THE INVENTION

The subject invention resolves the above-described needs and problems by providing a coaxial resonator which has a conductive housing, a conductive cylindrical post and a high dielectric constant tubular ceramic insert. The physical arrangement of the elements is such that the post and ceramic insert are stacked and attached to the housing so that the bottom surface of the post abuts the floor of the housing while the top surface of the ceramic insert abuts the roof of the housing. Accordingly, the air gap of traditional resonator designs is completely filled in the axial direction of the post by the ceramic insert.

In a first embodiment of the invention, the air gap between the post and the housing roof is filled with a high dielectric constant ceramic tubular insert that occupies the full axial dimension and at least partially fills the radial dimension that encompasses the gap.

In a second embodiment of the invention, the air gap between the cylindrical conductive post and the conductive housing is filled with two or more ceramic tubular dielectric inserts having different dielectric constants. Additional embodiments include arrangements that incorporate a tuning screw that can be adjustably introduced from the external surface of the housing's roof to partially penetrate the space defined by the ceramic tubular insert.

Accordingly, it is an object of the present invention to provide a resonator which occupies a much smaller volume that present designs.

It is an additional object of the present invention to provide a resonator that delivers greatly increased spurious mode separation.

It is an additional object of the present invention to provide a resonator with the above characteristics that and has a -relatively high Quality Factor.

These and other objects, features, and advantages of the present invention may be more clearly understood and appreciated from a review of ensuing detailed description of the preferred and alternate embodiments and by reference to the accompanying drawings and claims.

### BRIEF DESCRIPTION OF THE DRAWINGS

FIG. 1 is a prospective view in partial cutaway of a first embodiment of the coaxial resonator structure in accordance with the present invention.

FIGS. 2A-2C are perspective, side and top views of the high dielectric constant ceramic tubular insert in accordance with the present invention.

FIGS. 3A-3C are perspective, side and top views of the resonator's post in accordance with the present invention.

FIG. 4 is a side cross-section view of a first embodiment of the coaxial resonator structure in accordance with the present invention.

FIG. 5 is a side cross-section view of a second embodiment of the coaxial resonator structure in accordance with the present invention that incorporates multiple ceramic tubular dielectric inserts.

FIG. 6 is a side cross-section view of a third embodiment of the coaxial resonator structure in accordance with the present invention that incorporates a tuning screw mechanism.

FIGS. 7A-7B are diagrammatical representations of coaxial resonator structures in accordance with the present invention and the prior art, labeled with dimensional variables for comparison of the various physical and performance characteristics of various examples of resonator configurations.

### DETAILED DESCRIPTION OF THE PREFERRED EMBODIMENT

While the present invention will be described more fully hereinafter with reference to the accompanying drawings, in which a preferred embodiment of the present invention is shown, it is to be understood at the outset of the description which follows that persons of skill in the appropriate arts may modify the invention herein described while still achieving the favorable results of this invention. Accordingly, the description which follows is to be understood as being a broad, teaching disclosure directed to persons of skill in the appropriate arts, and not as limiting upon the present invention.

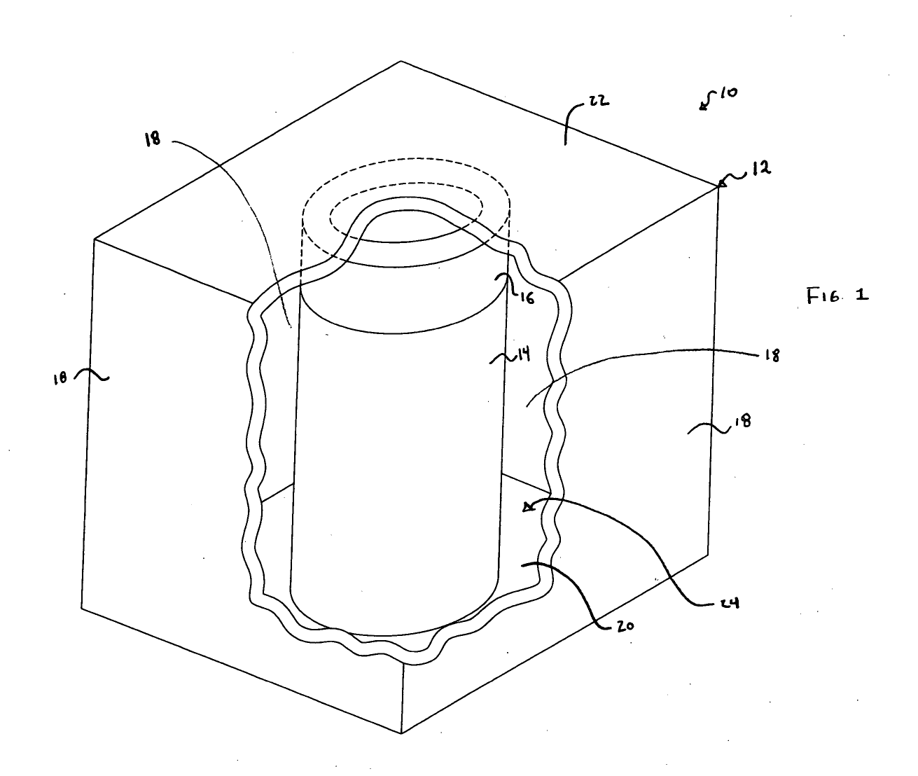

Referring initially to FIG. 1 of the drawings, in which like numerals indicate like elements throughout the several figures, shown is a coaxial resonator structure according to one embodiment of the present invention. The resonator structure (10) includes a housing (12), a post (14) and a dielectric insert (16). The housing (12) defines a fully enclosed cavity and is rectangular in shape having a square foot print and a rectangular cross section. The housing (12) is formed by four side walls (18), a flat floor (20) and a flat roof (22) all of which define an air-filled cavity (24). The post (14) is cylindrical in shape having an opening bored through its top end and a closed bottom end. The dielectric insert (16) is tubular in shape consisting of a fully bored cylindrical segment. Both the post (12) and dielectric insert (16) have fully circular cross sections.

The housing (12), post (14) and ceramic dielectric insert (16) are arranged by stacking the dielectric insert (16) on the top surface of post (14) so that the bottom surface of the dielectric insert (16) abuts the top surface of the post (14). The dielectric insert (16) and post (14) assembly is the inserted within the housing (12). For this purpose, one or more of the side walls (18), roof (22) or floor (22) are removably attached to the housing. The dielectric insert (16) and post (14) assembly is installed within the housing so that the bottom surface of the post (14) and the top surface of the dielectric insert (16) directly abut the floor (20) and roof (22) inner surfaces respectively. The dielectric insert (16) and post (14) are dimensioned along their longitudinal axis so that when stacked as an assembly there is a frictional fit between the floor (20) and roof (22) inside surfaces. The dielectric insert (16) and post (14) assembly is also generally centered on both the floor (20) and roof (22) surfaces.

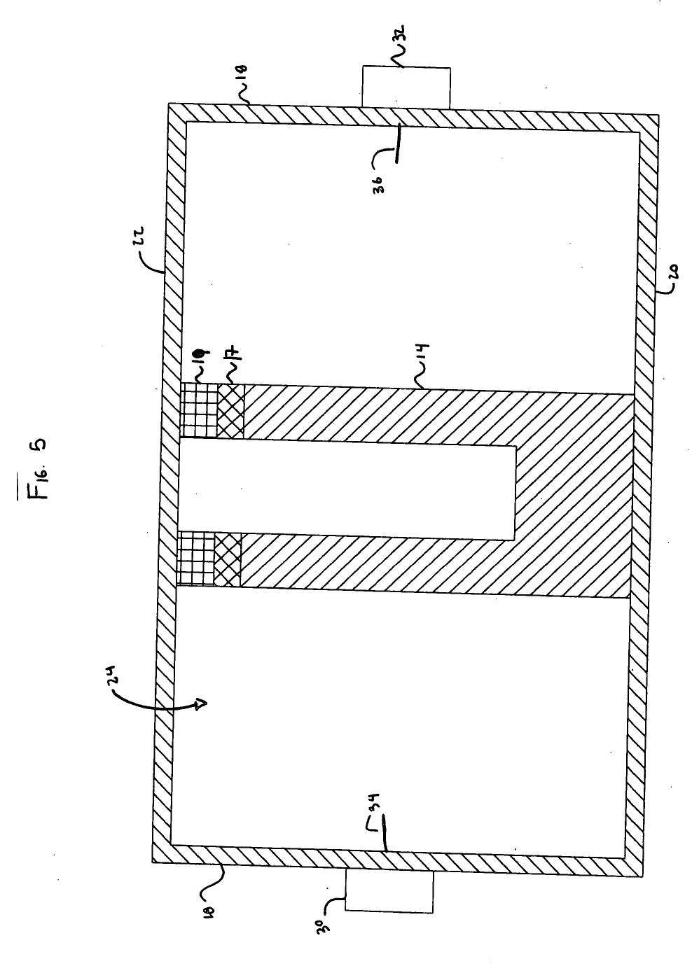

Also present are input (30) and output (32) ports (shown in FIGS. 4, 5 and 6) for coupling microwave energy through the structure. The input (30) and output (32) ports are further conventionally equipped with coupling probes (34) and (36) that are impedance matched for coupling into the housing's cavity (24.)

The housing (12) is preferably constructed from silver plated aluminum. The post (14) is preferably constructed from silver plated aluminum or copper. However, other electrically conductive materials, or combinations thereof, can be used for both the body and plating on the housing (12) and post (14). The dielectric insert (16) can be constructed from a variety of materials depending on the physical properties desired during operation. Typical materials from which the dielectric insert (16) may be constructed include: (a) (Zr,Sn)TiO₄, having a dielectric constant (“εr”) of 38.0; (b) Ba(Zr,Zn,Sn)O₃—Εr=29.0; (c) Zr/Sn Titranate—εr=36.0; and (d) Barium Tetratitranate—εr=36.0. Like the housing, other materials having varying physical characteristics may be utilized for the dielectric insert (16.)

In the preferred embodiment, the post (14) and dielectric insert (16) are held in place with respect to each other and the housing through mechanical friction. However, other means such as fasteners or adhesives may be utilized for this purpose while keeping in mind that it is desirable that the contact areas between the various elements should be kept as free of contaminants and extraneous materials as possible.

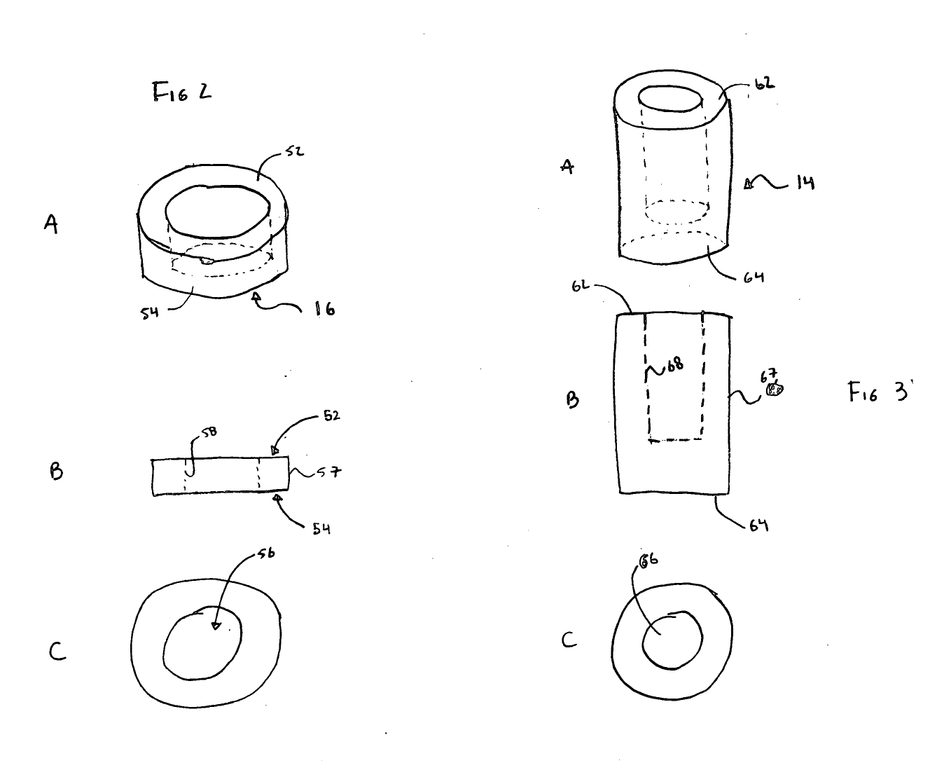

FIG. 2 illustrates detailed perspective (A), side (B) and top (C) views of a dielectric insert (16) in accordance with the present invention. As previously explained, the dielectric insert consists of a right cylindrical section having top (52) and bottom (54) ends and a fully bored opening (56) traversing the dielectric insert (16) along its longitudinal axis. The outer (57) and inner (58) walls of the dielectric insert (16) are preferably smooth.

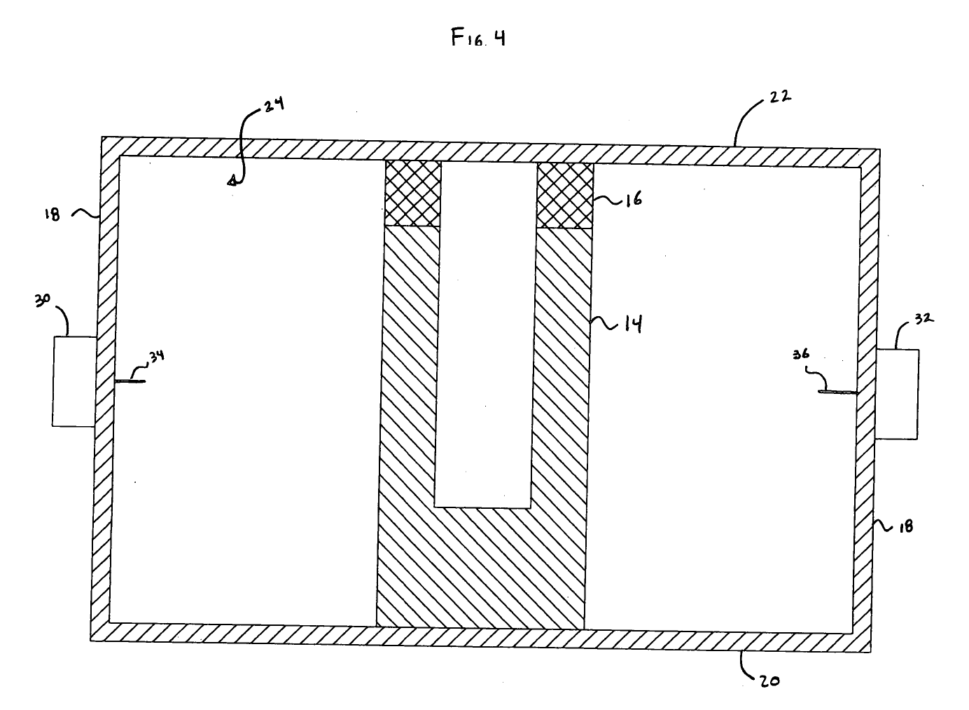

FIG. 3 illustrates detailed perspective (A), side (B) and top (C) views of a post (14) in accordance with the present invention. As previously explained, the post consists of a right cylindrical structure having top (62) and bottom (64) ends and an opening (66) bored through the top surface (62) and traversing the post (14) for part of the way along its longitudinal axis. The outer (67) and inner (68) walls of the post (14) are preferably smooth.

FIGS. 4-6 illustrate a side cross-sectional views of various embodiment of the resonator structure in accordance with the present invention. FIG. 4 is a cross sectional representation of the resonator structure shown in FIG. 1 including all of the elements described in the above paragraphs.

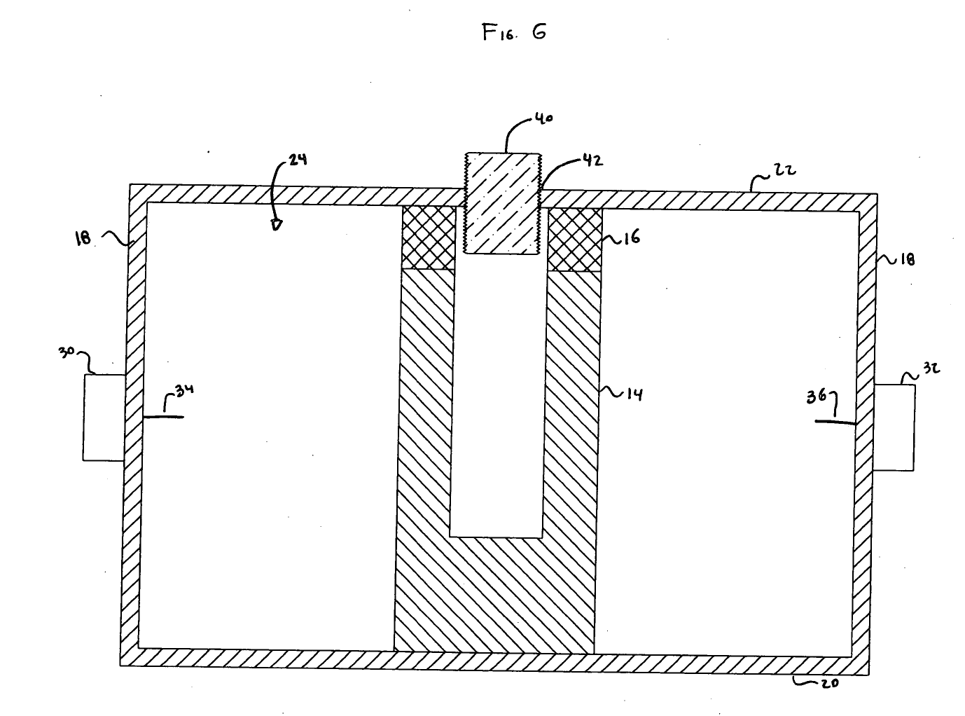

FIG. 5 is an example of a resonator similar to that shown in FIG. 4 with the exception that the single dielectric insert (16) is replaced by two separate dielectric inserts (17) and (19) whose dimensions and/or materials could be different from each other in order to achieve different performance characteristics.

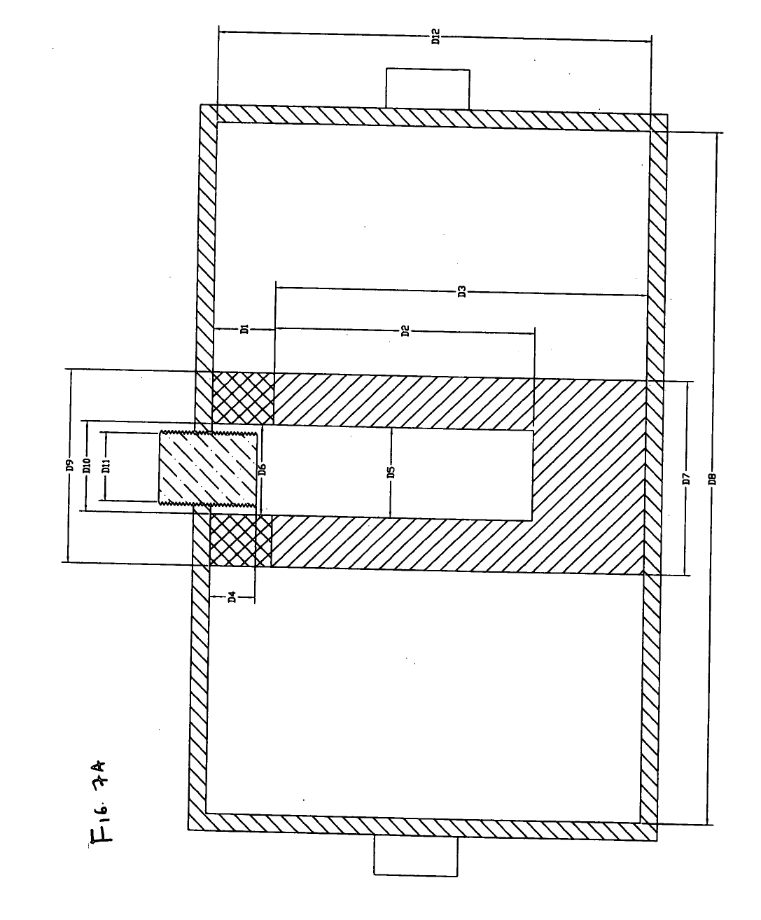

FIG. 6 is an example of a resonator similar to that shown in FIG. 4 with the exception that a tuning screw (40) has been added. The tuning screw is introduced through an opening in the roof (22) which is situated so as to coincide with the openings (56 and 66) bored through the dielectric insert (16) and post (14). The tuning screw (40) penetrates the housing's roof (22) through a threaded interface (42) which permits adjustment of the length of penetration of the tuning screw (40). By gradually turning the tuning screw (40), the resonant frequency of the resonator can be fine tuned during its operation.

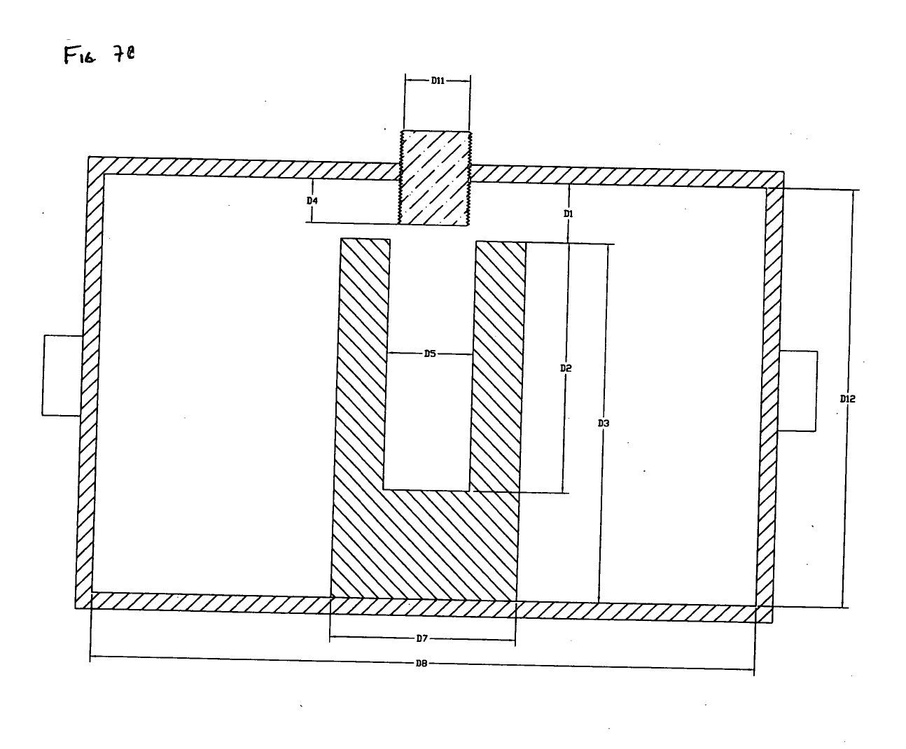

Referring next to FIGS. 7A-7B, shown are diagrammatical representations of coaxial resonator structures in accordance with the present disclosure and the prior art, labeled with dimensional variables for comparison of the various physical and performance characteristics of various examples of resonator configurations. Using FIGS. 7A and 7B, examples of resonators targeting the same frequency can be constructed and represented using both the presently disclosed invention and the prior art. In the prior art examples, the dielectric insert (16) is removed and replaced with an air gap. In order to be able to resonate at the same frequency, however, the overall height of the prior art structure is generally much greater than the overall height of newly disclosed structure, thus resulting in a larger volume resonator structure.

For comparison purposes, the below examples will illustrate the resulting performance characteristics (i.e. Quality Factor, primary-spurious Frequency Separation, and Volume) for resonators in accordance with the prior invention and resonators in the prior art. As illustrated in the examples, at the given frequency the disclosed resonator consistently provide similar Quality Factor and a wider Frequency Separation in a much lower volume package than resonators in the prior art.

### EXAMPLE 1

TABLE 1
Mechanical Configuration (Example 1)

| | | Value (mm) | Value (mm) |
|---|---|---|---|
| | | Resonator in | Resonator in |
| Variable | | accordance | accordance |
| (See FIGS. | | with present | with |
| 7A, 7B) | Description | disclosure | prior art |
| D1 | Dielectric insert height/air gap | 3.50 | 1.00 |
| D2 | Post bore depth | 14.00 | 36.50 |
| D3 | Post height | 21.50 | 49.00 |
| D4 | Tuning screw depth | 2.60 | 3.30 |
| D5 | Post bore diameter | 5.20 | 5.60 |
| D7 | Post outer diameter | 11.20 | 11.20 |
| D8 | Cavity width | 40.00 | 40.00 |
| D9 | Dielectric insert outside | 11.20 | N/A |
| | diameter | | |
| D10 | Dielectric insert inside | 5.20 | N/A |
| | diameter | | |
| D11 | Tuning screw diameter | 4.82 | 4.82 |
| D12 | Cavity height | 25.00 | 50.00 |
| Not Shown | dielectric constant (“εᵣ”) of | 21 | 1 |
| | dielectric insert (or air gap for | | |
| | prior art) | | |

TABLE 2
Performance Comparison (Example 1)

| | Value | Value | |
|---|---|---|---|
| | Resonator in | Resonator in | |
| Parameter | accordance with | accordance | |
| (Calculated) | disclosed invention | with prior art | % Difference |
| Targeted Frequency | 888.122 | 881.436 | 0.75% |
| (MHz) | | | |
| Quality Factor | 2605 | 2989 | (12.84%) |
| First spurious resonant | 5987 | 3230 | 85.4% |
| frequency (MHz) | | | |
| Total Volume (cc) | 400 | 800 | (50.0%) |

### EXAMPLE 2

TABLE 3
Mechanical Configuration (Example 2)

| | | Value (mm) | Value (mm) |
|---|---|---|---|
| | | Resonator in | Resonator in |
| Variable | | accordance | accordance |
| (See FIGS. | | with present | with |
| 7A, 7B) | Description | disclosure | prior art |
| D1 | Dielectric insert height/air gap | 1.25 | 1.00 |
| D2 | Post bore depth | 16.25 | 36.50 |
| D3 | Post height | 21.25 | 91.00 |
| D4 | Tuning screw depth | 0.10 | 18.00 |
| D5 | Post bore diameter | 5.60 | 5.60 |
| D7 | Post outer diameter | 11.20 | 11.20 |
| D8 | Cavity width | 40.00 | 40.00 |
| D9 | Dielectric insert outside | 11.20 | N/A |
| | diameter | | |
| D10 | Dielectric insert inside | 5.60 | N/A |
| | diameter | | |
| D11 | Tuning screw diameter | 4.82 | 4.82 |
| D12 | Cavity height | 22.50 | 92.00 |
| Not Shown | dielectric constant (“εᵣ”) of | 35 | 1 |
| | dielectric insert (or air gap for | | |
| | prior art) | | |

TABLE 4
Performance Comparison (Example 2)

| | Value | Value | |
|---|---|---|---|
| | Resonator in | Resonator in | |
| Parameter | accordance with | accordance | |
| (Calculated) | disclosed invention | with prior art | % Difference |
| Targeted Frequency | 479.118 | 482.459 | (0.69%) |
| (MHz) | | | |
| Quality Factor | 1742 | 2328 | (25.17%) |
| First spurious resonant | 6599 | 1757 | 275.6% |
| frequency (MHz) | | | |
| Total Volume (cc) | 360 | 1472 | (75.5%) |

### EXAMPLE 3

TABLE 5
Mechanical Configuration (Example 3)

| | | Value (mm) | Value (mm) |
|---|---|---|---|
| | | Resonator in | Resonator in |
| Variable | | accordance | accordance |
| (See FIGS. | | with present | with |
| 7A, 7B) | Description | disclosure | prior art |
| D1 | Dielectric insert height/air gap | 2.15 | 1.00 |
| D2 | Post bore depth | 14.73 | 35.75 |
| D3 | Post height | 20.35 | 48.00 |
| D4 | Tuning screw depth | 0.10 | 6.20 |
| D5 | Post bore diameter | 4.40 | 4.40 |
| D7 | Post outer diameter | 10.00 | 8.80 |
| D8 | Cavity width | 36.00 | 30.00 |
| D9 | Dielectric insert outside | 10.00 | N/A |
| | diameter | | |
| D10 | Dielectric insert inside | 5.60 | N/A |
| | diameter | | |
| D11 | Tuning screw diameter | 3.50 | 3.50 |
| D12 | Cavity height | 16.88 | 36.75 |
| Not Shown | dielectric constant (“εᵣ”) of | 21 | 1 |
| | dielectric insert (or air gap for | | |
| | prior art) | | |

TABLE 6
Performance Comparison (Example 3)

| | Value | Value | |
|---|---|---|---|
| | Resonator in | Resonator in | |
| Parameter | accordance with | accordance | |
| (Calculated) | disclosed invention | with prior art | % Difference |
| Targeted Frequency | 907.488 | 903.313 | 0.46% |
| (MHz) | | | |
| Quality Factor | 2272 | 2310 | (1.64%) |
| First spurious resonant | 6683 | 3273 | 104.2% |
| frequency (MHz) | | | |
| Total Volume (cc) | 218 | 331 | (34%) |

As shown in the above examples, the two resonators in each example target essentially the same frequency. The resonators in examples 1 and 2 have a difference in Quality Factor that is negligible for most applications yet the total volume occupied by the novel structure in these examples occupies 50% and 75% less of the volume as the equivalent structure according to the prior art. Example 3 demonstrates that a resonator according to the present invention with a virtually identical Quality Factor as a resonator in the prior art still occupies approximately 34% less volume.

Accordingly, it will be understood that the preferred embodiment of the present invention has been disclosed by way of example and that other modifications and alterations may occur to those skilled in the art without departing from the scope and spirit of the appended claims.

What is claimed is:

1. A coaxial resonator comprising:
a housing defining a fully enclosed cavity, the housing having a vertical axis, a flat floor, a flat roof parallel to said flat floor, and at least one peripheral wall perpendicular to said flat floor and said flat roof and parallel to said vertical axis;
a post having a post bottom end and a post top end and a post axis extending from said post bottom end to said post top end; and
a dielectric insert having an insert bottom end, an insert top end and an insert axis extending from said insert bottom end to said insert top end;
wherein said post and dielectric insert are completely enclosed within said housing and, said post and dielectric insert are disposed so that said post bottom end is juxtaposed with said flat floor, said insert bottom end is juxtaposed with said post top end, and said insert top end is juxtaposed with said flat roof.

2. The coaxial resonator of claim 1 wherein said housing vertical axis, said post axis and said insert axis are co-incident.

3. The coaxial resonator of claim 1 wherein the cross section of said peripheral wall describes a rectangle.

4. The coaxial resonator of claim 1 wherein the cross section of said peripheral wall describes a circle.

5. The coaxial resonator of claim 1 wherein the cross section of said peripheral wall describes an ellipse.

6. The coaxial resonator of claim 1 wherein the cross section of said peripheral wall describes a polygon.

7. The coaxial resonator of claim 1 wherein said dielectric insert is constructed from a ceramic material.

8. The coaxial resonator of claim 7 wherein said ceramic material is selected from among the group of materials consisting of (Zr,Sn)TiO₄, Ba(Zr,Zn,Sn)O₃, Zr/Sn Titranate, Barium Tetratitranate, and combinations thereof.

9. The coaxial resonator of claim 1 wherein said dielectric insert is constructed from a material having a dielectric constant greater than 20.0

10. The coaxial resonator of claim 1 wherein said housing is constructed from an electrically conductive material.

11. The coaxial resonator of claim 1 wherein said housing is constructed from silver-plated aluminum.

12. The coaxial resonator of claim 1 wherein said post is constructed from an electrically conductive material.

13. The coaxial resonator of claim 1 wherein said post is constructed from silver-plated aluminum.

14. The coaxial resonator of claim 1 wherein a portion of said peripheral wall is removable.

15. The coaxial resonator of claim 1 wherein said post is a right cylinder.

16. The coaxial resonator of claim 1 wherein said post is tubular.

17. The coaxial resonator of claim 15 wherein said post has an opening bored through said top end and a said bottom end is closed.

18. The coaxial resonator of claim 1 wherein said dielectric insert is a right cylinder.

19. The coaxial resonator of claim 1 wherein said dielectric insert is tubular.

20. The coaxial resonator of claim 1 further comprising input and output ports for coupling microwave energy through said resonator.

21. The coaxial resonator of claim 1 wherein said input and output ports are equipped with impedance-matched coupling probes.

22. The coaxial resonator of claim 1 further comprising a tuning screw adjustably threaded through said flat roof.

23. A coaxial resonator comprising:
a housing defining a fully enclosed cavity, the housing having a vertical axis, a flat floor, a flat roof parallel to said flat floor, and at least one peripheral wall perpendicular to said flat floor and said flat roof and parallel to said vertical axis;
a post having a post bottom end and a post top end and a post axis extending from said post bottom end to said post top end; and
a first dielectric insert having a first insert bottom end, a first insert top end and a first insert axis extending from said first insert bottom end to said first insert top end;
a second dielectric insert having a second insert bottom end, a second insert top end and a second insert axis extending from said second insert bottom end to said second insert top end;
wherein said post, said first dielectric insert and said second dielectric insert are completely enclosed within said housing and, said post, said first dielectric insert and said second dielectric insert are disposed so that said post bottom end is juxtaposed with said flat floor, said first insert bottom end is juxtaposed with said post top end, said second insert bottom end is juxtaposed with said first insert top end and said second insert top end is juxtaposed with said flat roof.

24. The coaxial resonator of claim 23 wherein said housing vertical axis, said post axis, said first insert axis and said second insert axis are co-incident.

25. The coaxial resonator of claim 23 wherein the cross section of said peripheral wall describes a rectangle.

26. The coaxial resonator of claim 23 wherein the cross section of said peripheral wall describes a circle.

27. The coaxial resonator of claim 23 wherein the cross section of said peripheral wall describes an ellipse.

28. The coaxial resonator of claim 23 wherein the cross section of said peripheral wall describes a polygon.

29. The coaxial resonator of claim 23 wherein said first dielectric insert and said second dielectric insert are constructed from the same ceramic material.

30. The coaxial resonator of claim 29 wherein said ceramic material is selected from among the group of materials consisting of (Zr,Sn)TiO4, Ba(Zr,Zn,Sn)O3, Zr/Sn Titranate, Barium Tetratitranate, and combinations thereof.

31. The coaxial resonator of claim 23 wherein said first dielectric insert and said second dielectric insert are constructed from different ceramic materials.

32. The coaxial resonator of claim 31 wherein said ceramic materials are selected from among the group of materials consisting of (Zr,Sn)TiO4, Ba(Zr,Zn,Sn)O3, Zr/Sn Titranate, Barium Tetratitranate, and combinations thereof.

33. The coaxial resonator of claim 23 wherein said first dielectric insert and said second dielectric insert are constructed from one or more materials having a dielectric constant greater than 20.0

34. The coaxial resonator of claim 23 wherein said housing is constructed from an electrically conductive material.

35. The coaxial resonator of claim 23 wherein said housing is constructed from silver-plated aluminum.

36. The coaxial resonator of claim 23 wherein said post is constructed from an electrically conductive material.

37. The coaxial resonator of claim 23 wherein said post is constructed from silver-plated aluminum.

38. The coaxial resonator of claim 23 wherein a portion of said peripheral wall is removable.

39. The coaxial resonator of claim 23 wherein said post is a right cylinder.

40. The coaxial resonator of claim 23 wherein said post is tubular.

41. The coaxial resonator of claim 39 wherein said post has an opening bored through said top end and a said bottom end is closed.

42. The coaxial resonator of claim 23 wherein said-first dielectric insert and said second dielectric insert are right cylinders.

43. The coaxial resonator of claim 23 wherein said first dielectric insert and said second dielectric insert are tubular.

44. The coaxial resonator of claim 23 wherein either said first dielectric insert or said second dielectric insert is tubular.

45. The coaxial resonator of claim 23 further comprising input and output ports for coupling microwave energy through said resonator.

46. The coaxial resonator of claim 23 wherein said input and output ports are equipped with impedance-matched coupling probes.

47. The coaxial resonator of claim 23 further comprising a tuning screw adjustably threaded through said flat roof.
